(19) United States
(12) Patent Application Publication
(10) Pub. No.: US 2019/0135473 A1
(43) Pub. Date: May 9, 2019

(54) CYLINDRICAL SHRINK WRAPS AND APPARATUS AND METHOD OF APPLYING SAME

(71) Applicant: Johanne Vermette, Beloeil (CA)

(72) Inventor: Johanne Vermette, Beloeil (CA)

(21) Appl. No.: 16/181,581

(22) Filed: Nov. 6, 2018

Related U.S. Application Data
(60) Provisional application No. 62/582,156, filed on Nov. 6, 2017.

(51) Int. Cl. B65C 3/06; B29C 65/66; B29C 65/00

(52) U.S. Cl. CPC B65C 3/065; B29C 65/665; B29L 2031/712; B29C 66/91; B29C 66/71

(57) ABSTRACT

Systems, apparatuses, and methods of protecting the outer surface of a cylinder for containing fluid. The cylinder includes a heat shrinkable polymer sleeve configured to shrink onto the cylinder with the application of heat. The apparatuses include and a ventilated enclosure having a heating assembly configured to distribute heat gradually or in increments to the shrinkable polymer sleeve.

### CROSS-REFERENCE TO RELATED APPLICATIONS

This application is a Continuation of co-pending U.S. Provisional Patent Application Ser. No. 62/582,156 filed Nov. 6, 2017 the disclosures of which are hereby incorporated by reference.

### BACKGROUND OF THE INVENTION

The present invention relates to fluid-filled cylinders and the protection and labeling thereof. Fluid-filled cylinders are used in various industries such as the medical, pharmaceutical and chemical industries for containing fluid in the form of gas or liquid under compression. These cylinders are typically designed for single or refillable use.

Known refillable cylinders are commonly made of metal, such as steel or aluminum, and painted either for cosmetic reasons or to comply with industry standards for identification of fluid contents and environmental or cautionary warnings. For example, in Canada, oxygen-containing cylinders are painted a standard white color, while in the United States they are painted a standard green color. Other product information, some of which is mandatory, is typically printed on labels affixed to the cylinders.

When these cylinders are emptied, they can either be refilled with the same substance or a different substance altogether. In the case of the latter, relabeling is required and it may be necessary to repaint the cylinders a different color to indicate the new substance and/or apply new mandatory notifications on labels, printing or painting.

When refilled with the same substance, typically no repainting or relabeling is required unless the original paint, printing or labeling is worn or otherwise illegible. Over time and with handling, there is a tendency for the paints and labels to peel off or exhibit other wear characteristics such as scratches and fading. Further, metal cylinders may rust due to exposure to the elements. For many cylinder companies which sell fluid-filled cylinders and refill emptied cylinders, the look of the cylinder is an important feature of the product. Consequently, many cylinder companies have adopted a policy of repainting and relabeling emptied cylinders every time they are returned by customers for re-filling. The associated costs of cylinder maintenance are therefore quite substantial.

To overcome the inadequacies of painting or peeling and reapplying affixed labels, cylinder companies have looked to solutions involving the use and application of shrink wrap to the outer surface of the cylinder. The application of shrink wrap allows for protection of the existing paint or labels on the cylinder, or allows for the shrink wrap to be colored or printed on to replace the paint or labels. Various aspects of the shrink wrap design and method of application are further described in U.S. Pat. No. 6,105,777 incorporated by reference herein.

Presently and in the prior art cylinder companies manually apply the shrink wrap labels with heat guns. The process generally entails manually inserting the cylinder into a shrink wrap sleeve and applying heat through the heat gun until the fit is proper. While the application of shrink wrap to fluid-filled cylinders has been beneficial, the current process of applying the shrink wrap to the fluid-filled cylinders is tedious and time consuming and requires a significant amount of man hours.

An object of the invention is therefore to provide a new and improved apparatus and method of applying shrink wrap sleeves to fluid-filled cylinders in a more cost efficient and time efficient manner.

### SUMMARY OF THE INVENTION

The present invention is directed to a system, heating apparatus and method for the efficient application of shrinkable polymer sleeves onto fluid cylinders of the type fillable with pressurized fluids, such as gases. The system generally comprises at least one cylinder assembly and at least one heating apparatus as described herein.

The at least one cylinder assembly comprises a fluid cylinder inserted into a shrinkable polymer sleeve and an optional cover member covering the releasable valve of the cylinder. The cover member is configured to protect the releasable valve during the shrink wrap process.

The heating apparatus generally comprises a ventilated enclosure having a support base configured to support the cylinder assembly, a support top, a heating assembly support system coupled to and interconnecting the support base and support top, and a heating assembly coupled to the heating assembly support system configured to bilaterally traverse the support system along a centrtal longitudinal axis of the cylinder assembly.

In one aspect of the invention, the heating assembly comprises a generally annular housing member having a cylinder clearance opening configured to concentrically surround the cylinder assembly while the heating assembly traverses the centrtal longitudinal axis of the cylinder assembly. The cylinder clearance opening is further configured in a shape to provide optimal and even heat distribution from the heating assembly to the cylinder assembly. The annular housing member may additionally comprise ventilation openings facing the cylinder clearance opening configured to aid in heat transfer from a heating element disposed within the annular housing member to the shrinkable polymer sleeve of the cylinder assembly. The heating element housed within the heating assembly is further configured to attain temperatures capable of shrinking the polymer sleeve around the cylinder. In some embodiments the heating assembly additionally comprises at least one fan to facilitate convective heat transfer from the heating element through the ventilation openings onto the shrinkable polymer wrap.

The heating element may employ any known heat source, including, without limitation, electrical resistance, electrical induction, magnetic induction, forced air, radio-frequency (RF), infrared (IR), ultrasonic, microwave, ultraviolet, or the like.

The heating assembly support system may comprise a conveyer belt system or a moveable platform system. Embodiments utilizing a conveyer belt system are configured such that a top gear or top pulley coupled to the support top, and a bottom gear coupled to the support base, are coupled together through a conveyer belt. In this embodiment, the heating assembly is coupled to the conveyer belt as well. A motor or equivalent device such as a hand crank is then used to drive the top or bottom gear causing the conveyer belt, and in turn the heating assembly, to move either towards or away from the support top along the centrtal longitudinal axis of the cylinder assembly. In operation, the heating assembly is configured to traverse the cylinder assembly along the centrtal longitudinal axis of the cylinder assembly while evenly and circumferentially distributing heat to the shrinkable polymer wrap. In order to provide additional support and stability, the heating assembly may be moveably coupled to vertical rails extending from the support base to the support top to limit out of plane movement.

Some embodiments of the heating assembly support system may comprise a mechanized or pneumatically driven platform coupled to the support base and heating assembly configured to raise or lower the heating assembly along the centrtal longitudinal axis of the cylinder assembly.

In one aspect of the invention, the heating apparatus is programmable or preprogramed with cylinder heights and shrinkable polymer sleeve properties such that conveyor belt or platform system moves at a predefined speed and the heating assembly heats to a predefined temperature.

In another aspect of the invention, a laser-guided computer control or time of flight sensor is coupled to the heating assembly and is configured to detect the cylinder assembly cover. In this aspect, a tripping of the sensor may cause the heating assembly to power down and the conveyer system or platform system to stop movement in order to ensure that the releasable valve is not damaged by the heating process.

In another aspect of the invention, a heat sensor or thermocouple may be coupled to the heating apparatus enclosure configured to give real time temperature data of the enclosure. The heat sensor may be configured to report to a computer system that adjusts ventilation openings or additional fans coupled to the enclosure to ensure proper temperatures of the enclosure for the shrink wrap process.

In yet another aspect of the invention, a plurality of heating apparatuses are linked together and configured by a central computer such that multiple cylinders can be assembled with similar process parameters at the same time.

In some configurations, the support base additionally comprises a turn table configured to continuously rotate the cylinder during the heat disbursement process to assure even heat transfer.

In another aspect of the invention the support base or support top include locking members configured fix the cylinder assembly in place with the enclosure.

In another aspect of the invention, an additional embodiment of the cylinder shrink wrap system is presented. The system may generally comprise at least one cylinder assembly at least one heating apparatus. The heating apparatus generally comprises a ventilated enclosure configured to house the cylinder assembly. The ventilated enclosure having a support base configured to support the cylinder assembly, a heating assembly coupled to the ventilated enclosure. The heating assembly may comprise a heating element including but not limited to infrared heat lamps. In some configurations, the heating assembly may include a single heating element while in other configurations the heating assembly may include multiple heating elements assembled to a single wall or multiple walls of the ventilated enclosure. In some embodiments the heating assembly or the ventilated enclosure additionally comprises at least one fan to provide convective heat transfer from the heating element to sleeve.

The additional system may comprise a single ventilated enclosure or a plurality of ventilated enclosures configured to operate independently or simultaneously. In some configurations of system, the support base may be part of an operational conveyer belt system configured move the cylinder assembly into and out of the ventilated enclosure.

Another aspect of the invention includes a method for protecting fluid-filled cylinders comprising the steps disposing a shrinkable polymer sleeve onto a fluid-filled cylinder, placing a cover over a valve of the fluid cylinder, placing the fluid cylinder onto a support base of a heating apparatus, enclosing the cylinder within the heating apparatus, activating an annular heating assembly to concentrically surround the cylinder and apply heat via a heating element within the heating assembly and a convection fan, translating the heating assembly along a centrtal longitudinal axis of the cylinder dispersing heat onto the shrinkable polymer sleeve, and shrinking the sleeve onto the cylinder.

The methods, systems, and apparatuses are set forth in part in the description which follows, and in part will be obvious from the description, or can be learned by the practice of the methods, apparatuses, and systems. The advantages of the methods, apparatuses, and systems will be realized and attained by means of elements and combinations particularly pointed out in the appended claims. It is to be understood that both the foregoing general description and the following detailed description are exemplary and explanatory only and are not restrictive of the methods, apparatuses, and systems, as claimed. More details concerning these embodiments, and others, are further described in the following figures and detailed description set forth herein below.

### BRIEF DESCRIPTION OF THE DRAWINGS

In the accompanying figures, like elements are identified by like reference numerals among the several preferred embodiments of the present invention.

FIGS. 1A-C represent side and top views of the cylinder shrink wrap system.

FIGS. 2A-D represent a fluid-filled cylinder, a shrink wrap sleeve, and a fluid-filled cylinder assembly.

FIG. 3 is a top view of an embodiment of the heating assembly.

FIGS. 4A-B represent side and top views of an additional embodiment cylinder shrink wrap system.

FIGS. 5A-B represent side and top views of an additional embodiment cylinder shrink wrap system.

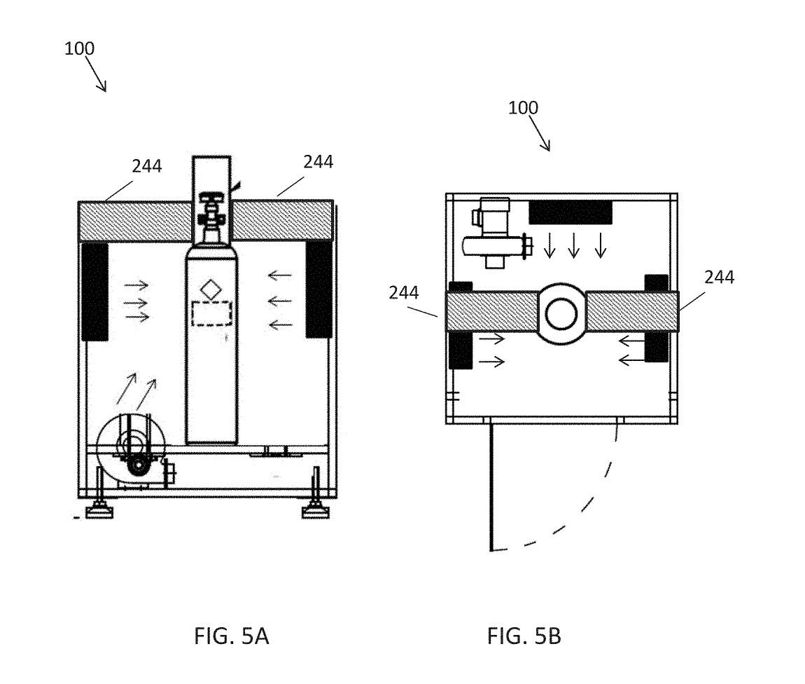

FIGS. 6A-B represent side and top views of an additional embodiment cylinder shrink wrap system.

FIGS. 7A-B represent side and top views of an additional embodiment cylinder shrink wrap system.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known customary practice within the art to which the invention pertains.

### DETAILED DESCRIPTION OF THE PREFERRED EMBODIMENTS

The foregoing and other features and advantages of the invention will become more apparent from the following detailed description of exemplary embodiments, read in conjunction with the accompanying drawings. The detailed description and drawings are merely illustrative of the invention rather than limiting, the scope of the invention being defined by the appended claims and equivalents thereof. It is to be noted by one of skill in the art that use of the term “about” in this specification is intended to connote a variance from a stated value or range of value by plus or minus 10 percent.

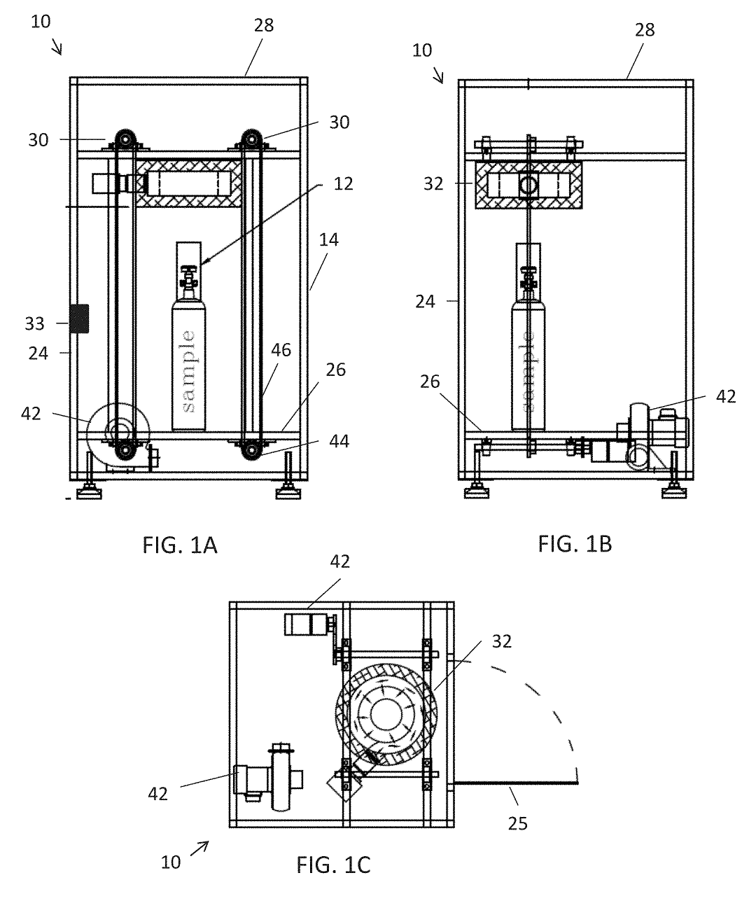

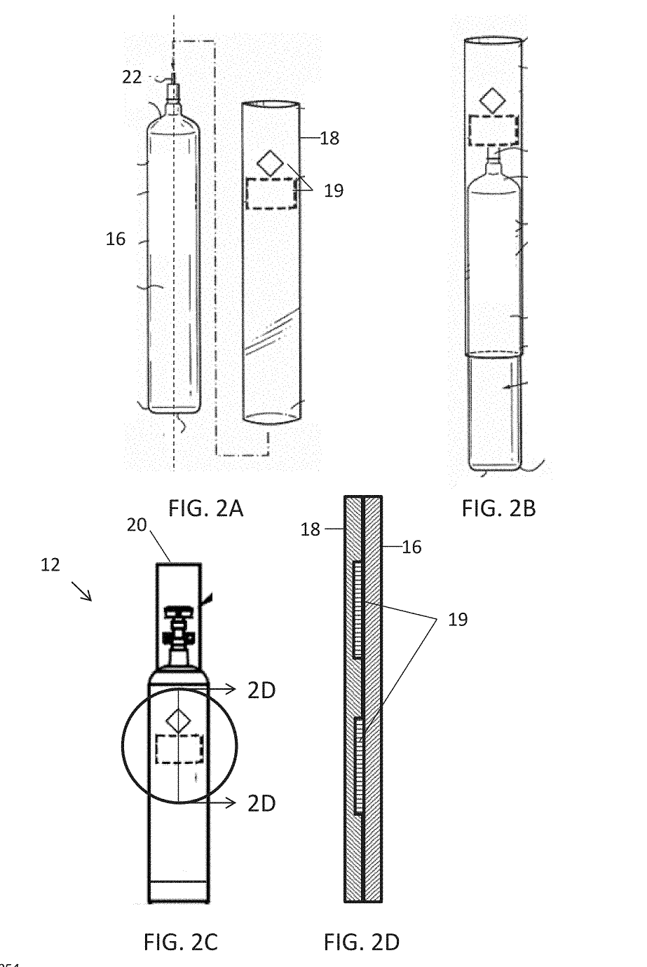

FIGS. 1-2C display an embodiment of a cylinder shrink wrap system 10. The cylinder shrink wrap system 10 as shown in FIGS. 1-2C generally comprises at least one cylinder assembly 12 and at least one heating apparatus 14.

The at least one cylinder assembly 12, further detailed in FIGS. 2A-C, comprises a fluid cylinder 16 inserted into a shrinkable polymer sleeve 18 and an optional cover member 20 covering the releasable valve 22 of the cylinder 16. The cover member 20 is configured to protect the releasable valve 22 during the shrink wrap process. The cover member 20 may be a cylindrical enclosure with an open bottom and open or bounded top portion and may be made of any material known by one of skill in the art including but not limited to cardboard or a thermoplastic capable of withstanding the heat of the heating apparatus 14. The shrinkable polymer sleeve 18 preferably has a length that is less that a length of the fluid cylinder 16 between an upper shoulder and a bottom base of the fluid cylinder 16.

The sleeve 18 may be made of a material selected from the group including but not limited to polyvinylchloride (PVC), polyethylene terephthalate (PET), polylactic acid (PLA), polytetrafluoroethylene, fluorinated ethylene propylene, perfluoralkoxy, ethylene tetrafluoroethylene, oriented polystyrene (OPS), or similar compatible polymers known by one of skill in the art. When heat is applied, the sleeve 18, shrinks both longitudinally and diametrically. Further, the sleeve 18 may have a shrink ratio with respect to the diameter thereof of from about 1.25:1 to about 4:1 and a thickness of from about 40 μm to about 80 In some configurations, the diametric shrink ratio for PET may be about 50% or 65% to about 75% and about 50% for. In some configurations, the length shrink ratio may be about 5% +/−3% or 10% +/−3% for PET. Additionally, the sleeve 18 may be transparent to reveal the color of a painted cylinder and any label affixed thereto. In this case, the sleeve 18 protects the paint and label from wear and exposure and the need to repaint and relabel is minimized, if not eliminated.

Alternatively, the sleeve 18 may be colored and/or include printing thereon such that the need for initial painting and/or labelling is reduced or eliminated. In these embodiments, the label 19 is printed on a rear surface of sleeve 18 in a reverse configuration such that when viewed through the transparent front surface the label appears in a non-reverse configuration. The labels may be printed in multiple layers using a rotogravure, flexography press, or similar commercial printing technologies known to one of skill in the art.

Sleeve 18 may be fabricated as a tubular member or as a sheet member which is then rolled into a tubular member. In this case, opposing ends of the sheet member are joined in a seam to form a tubular member.

In some embodiments an adhesive may be placed on the rear surface of the sleeve 18 prior to assembly to adhere to the cylinder 16 and hold the sleeve 18 in place prior to the heat shrink process.

The heating apparatus 14 as shown in FIGS. 1-2C generally comprises a ventilated enclosure 24 having a support base 26 configured to support the cylinder assembly 12, a support top 28, at least one heating assembly support system 30 coupled to and interconnecting the support base 26 and support top 28, and a heating assembly 32 coupled to the at least one heating assembly support system 30 configured to move vertically along a centrtal longitudinal axis A of the cylinder assembly 12, and at least opening or optional door 25 configured to open and seal the ventilated enclosure 24.

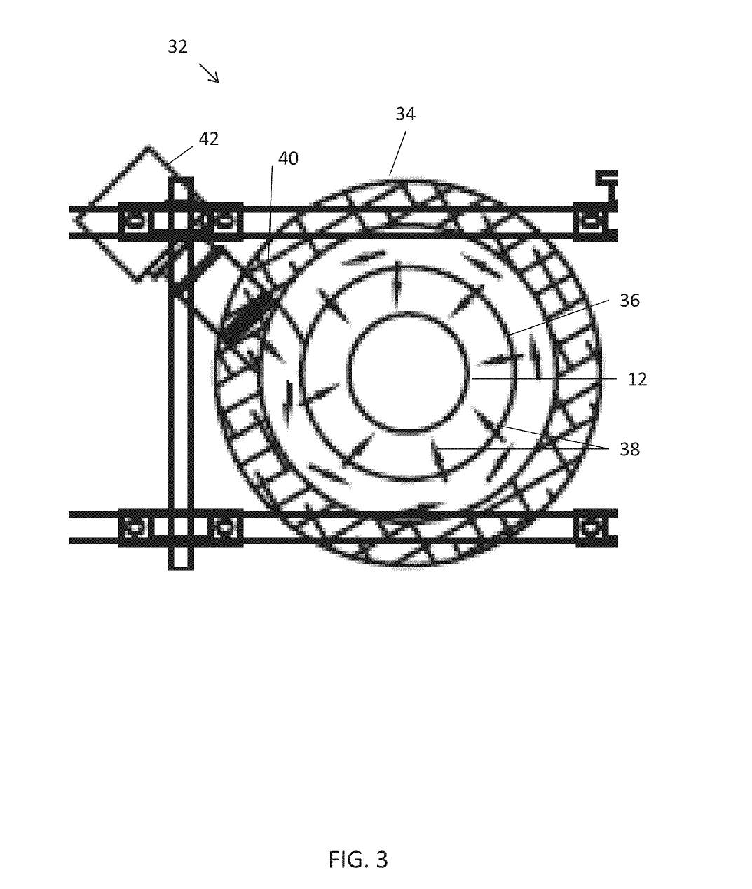

The heating assembly 32 as shown in FIG. 3 comprises a generally annular shaped housing member 34 having a cylinder clearance opening 36 configured to concentrically surround the cylinder assembly 12 while the heating assembly traverses the centrtal longitudinal axis A of the cylinder assembly 12. It is noted that the term “annular” is meant to describe a ring shape, elliptical shape, or any polygonal or irregular polygonal shape, having an outer perimeter and an inner perimeter defining and bounding an opening in said shape. The cylinder clearance opening 36 is further configured in a shape to provide optimal and even heat distribution from the heating assembly to the cylinder assembly 12. The cylinder clearance opening 36 may be a circular shape, but one of skill in the art may recognize that additional polygonal shapes including but not limited squares, equilateral triangles, pentagons, hexagons, and octagons may be used as well. The annular housing member 34 may additionally comprise at least one ventilation opening 38 or a plurality of ventilation openings 38 facing the cylinder clearance opening 36 configured to aid in heat transfer from a heating element 40 disposed within the annular housing member 34 to the shrinkable polymer sleeve 18 of the cylinder assembly 12. In some embodiments the heating assembly 32 or the ventilated enclosure 24 additionally comprises at least one fan 42 to provide convective heat transfer through from the heating element 40 through the ventilation openings 38 onto the shrinkable polymer sleeve 18.

In some embodiments, the heating element 40 housed within the heating assembly 32 may be annular in the shape of the housing member 34. In other embodiments there may be a plurality of discrete heating elements 40 where each element is placed at particular points around the inner perimeter of the housing member 34 such that the plurality of heating elements 40 surround the inner perimeter and cylinder clearance openings. In still yet additional embodiments, the heating element 40 may be a singular element or a plurality of elements disposed in proximity to the at least one fan 42 such that the fan 42 can be used to aid in convective heat transfer by circulating the heat generated by the heating element 40 throughout the housing member 34 and through the ventilation openings 38 on the shrinkable polymer sleeve 18. In an additional configuration, the heating element 40 may be an infrared heat lamp.

The heating element 40 may employ any known heat source, including, without limitation, electrical resistance, electrical induction, magnetic induction, forced air, radio-frequency (RF), infrared (IR), ultrasonic, microwave, ultraviolet, or the like.

The heating element 40 or in some configurations a plurality of heating elements 40 is/are further configured to attain temperatures capable of shrinking the polymer sleeve 18 around the cylinder. In some embodiments the temperature range may be from about 150 degrees Fahrenheit to about 500 degrees Fahrenheit. The temperature may be obtained by a single heating element 40 or multiple elements 40 combined in aggregate dispersing heat through the system 10 or through convection to the polymer sleeve 18.

The heating assembly 32 of system 10 is coupled to the heating assembly support system 30 and further configured to traverse the centrtal longitudinal axis A of the cylinder assembly 12. The heating assembly support system 30 may comprise a conveyer belt and gear system or a movable support platform system configured to move the heating assembly 32 up and down the centrtal longitudinal axis A of the cylinder assembly 12 gradually or in controlled increments. Embodiments utilizing a conveyer belt system may be configured such that a top gear or top pulley 42 coupled to the support top 28, and a bottom gear 44 coupled to the support base 26, are coupled together through a conveyer belt 46. In this embodiment, the heating assembly is coupled to the conveyer belt as well. A motor or equivalent device such as a hand crank is then used to drive the top gear 42 or bottom gear 44 causing the conveyer belt 46 to move up and down with the enclosure 24 and in turn the heating assembly 32 to move either towards or away from the support top 26 along the centrtal longitudinal axis A of the cylinder assembly 12. In operation, the heating apparatus 14 is configured to traverse the heating assembly 32 along the centrtal longitudinal axis A of the cylinder assembly 12 while evenly and circumferentially distributing heat to the shrinkable polymer sleeve 16. In order to provide additional support and stability, the heating assembly may be moveably coupled to vertical rails extending from the support base 26 or support top 28 to limit out of plane movement.

Some embodiments of the heating support system 30 may comprise a mechanized or pneumatically driven platform coupled to the support base 26 configured to gradually or in discrete increments raise or lower the heating assembly 32 along the centrtal longitudinal axis A of the cylinder assembly 12. In these embodiments, the heating assembly 32 may be directly coupled to the platform or to vertical rails extending from the support base 26 or support top 28 to limit provide additional stability.

In one aspect of the invention, the heating apparatus 14 is programmable or preprogramed with cylinder 16 heights and shrinkable polymer sleeve 18 properties such that conveyor belt or platform system moves at a predefined speed or in predefined distance increments and the heating assembly 32 heats to a predefined temperature.

Additional embodiments of the shrink wrap system 10 include a laser or infrared guided computer control or time of flight sensor 33 coupled to the heating assembly 32. The control/sensor is configured to detect the cylinder assembly 12 and cover 20. In these embodiments, a tripping of the sensor may cause the heating assembly 32 to power down and the conveyer belt system 46 or platform system to stop movement in order to ensure that the releasable valve is not damaged by the heating process. One of skill in the art may use additional sensors or substitute sensors in the art to achieve the same purpose, including but not limited to optical line of site sensors or mechanical switches that are tripped during movement.

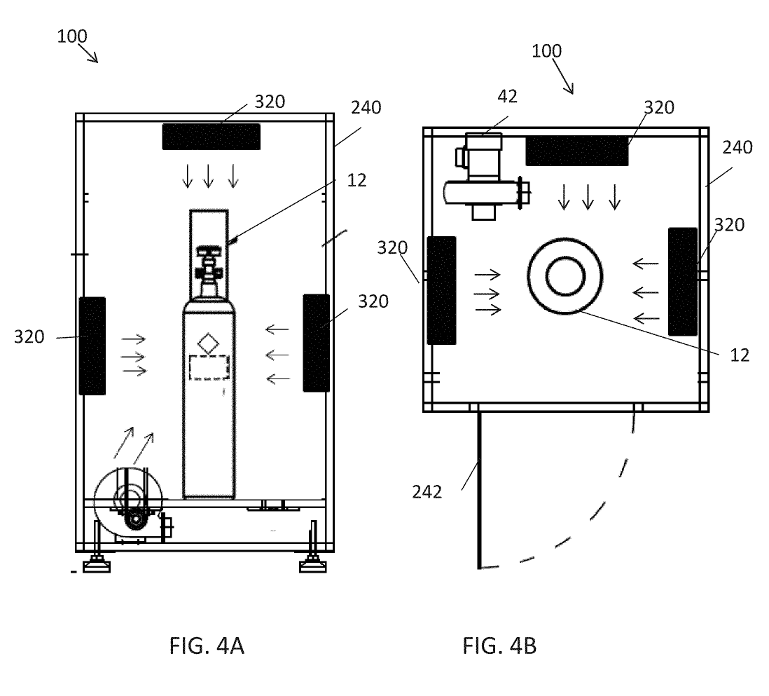

In another aspect of the invention, an additional embodiment of the cylinder shrink wrap system 100 is presented. As shown in FIGS. 4A-B the system 100 generally comprises at least one cylinder assembly 12 as described above and at least one heating apparatus 140. The heating apparatus 140 as shown in the side and top views of FIGS. 4A-B generally comprises a ventilated enclosure 240 configured to house the cylinder assembly 12 therein. The ventilated enclosure 240 having a support base 260 configured to support the cylinder assembly 12, a heating assembly 320 coupled to the ventilated enclosure 240, and at least one opening or optional door 242 configured to open and seal the ventilated enclosure 240. The heating assembly 320 may comprise a heating element 400 including but not limited to infrared heat lamps. In some configurations, the heating assembly 320 may include a single heating element 400 while in other configurations the heating assembly 320 may include multiple heating elements 400 assembled to a single wall or multiple walls of the ventilated enclosure 240. In some embodiments the heating assembly or the ventilated enclosure 240 additionally comprises at least one fan 420 to provide convective heat transfer from the heating element 320 to sleeve 18.

In another aspect of the invention the support base 26 or support top 28 include locking members (not shown) configured to lock the cylinder assembly 12 in place during the heat transfer process. The locking members may provide a compression fit on the cylinder assembly 12 in an area that is not to be covered by the shrinkable polymer sleeve 18.

The system 100 may comprise a single ventilated enclosure 240 or a plurality of ventilated enclosures configured to operate independently or simultaneously. In some configurations of system 100, the support base 260 may be part of an operational conveyer belt system configured move the cylinder assembly 12 into and out of the ventilated enclosure 240.

In another aspect of system 100 the support base the ventilated enclosure 240, may have an open top portion, and have additional support members 244 coupled to the side walls of the ventilated enclosure 240 configured support the cylinder assembly 12 while insulating the heat beneath the height of the releasable valve 22 such that the heat from the heating assembly 320 is only applied to the polymer sleeve 18 portion of the cylinder assembly 12.

In another aspect of system 100 the support base 260 or another portion of the ventilated enclosure 240, may include locking members to lock the cylinder assembly 12 in place during the heat transfer process. The locking members may provide a compression fit on the cylinder assembly 12 in an area that is not to be covered by the shrinkable polymer sleeve 18.

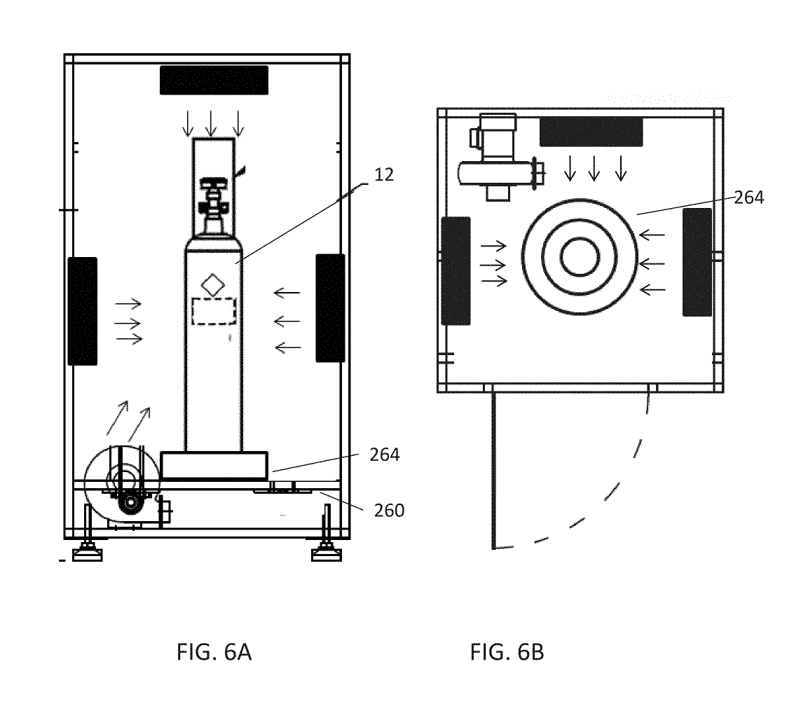

In some configurations of system 100, as shown in FIGS. 6A-B, the support base 260 additionally comprises a turn table 264 configured to continuously rotate the cylinder assembly 12 during the heat transfer process to ensure even heat transfer. System 10 may additionally comprise a turn table (not shown) configured as the similarly to the turn table 264 of system 100.

In another aspect of the invention, a heat sensor or thermocouple may be coupled to the ventilated enclosure 24, 240 configured to give real time temperature data of the enclosure. The heat sensor may be configured to report to a computer system that adjusts ventilation openings or additional fans 48, 480 coupled to the enclosure to ensure proper temperatures of the enclosure.

In yet another aspect of the invention, a plurality of heating apparatuses 14 or 140 are linked together and configured by a central computer such that multiple cylinder assemblies 12 can be assembled with similar process parameters at the same time.

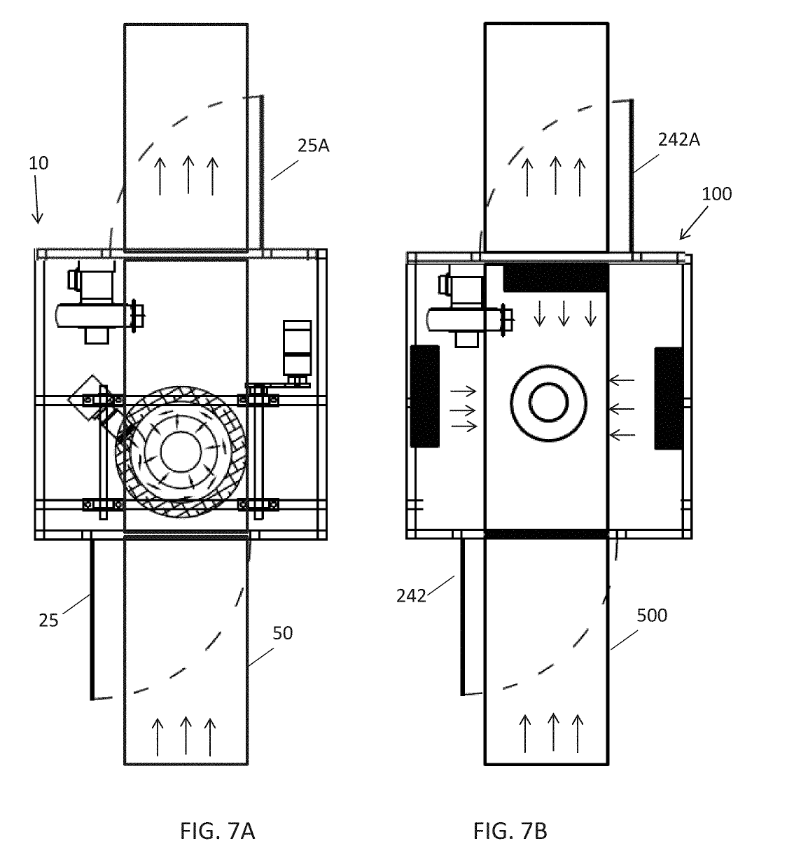

In either described system configurations 10, 100 as shown in FIGS. 7A-7B the heating apparatus 24, 240 may comprise a conveyer belt 50, 500, configured to move a cylinder assembly 12 into the ventilated enclosure through the opening or door 25, 242, into the ventilated enclosure and further move the cylinder assembly 12 out of the ventilated enclosure through the opening or door 25A, 242A when the shrink wrap process is complete.

Another aspect of the invention includes a method for protecting fluid-filled cylinders using system 10 comprising the steps disposing a shrinkable polymer sleeve onto a fluid-filled cylinder, placing a cover over a valve of the fluid cylinder, placing the fluid cylinder onto a support base of a heating apparatus, enclosing the cylinder within the heating apparatus, activating an annular heating assembly to concentrically surround the cylinder and apply heat via a heating element within the heating assembly and a convection fan, translating the heating assembly along a centrtal longitudinal axis of the cylinder dispersing heat onto the shrinkable polymer sleeve, and shrinking the sleeve onto the cylinder. Variations of the method include the steps of programming the heating apparatus with polymer sleeve parameters and cylinder parameters such that the heating assembly generates the proper amount of heat and travels the appropriate distances to shrink wrap the cylinder assembly. Additional variations may include calibrating motions sensors, switches, time of flight sensors, or laser/infra-red guides, to automatically detect the height of the cylinder assembly, location of the valve, and location of the sleeve and perform the heat transfer process accordingly.

Another aspect of the invention includes a method for protecting fluid-filled cylinders using system 100 comprising the steps disposing a shrinkable polymer sleeve onto a fluid-filled cylinder, placing a cover over a valve of the fluid cylinder, placing the fluid cylinder onto a support base of a heating apparatus, enclosing the cylinder within the heating apparatus, activating a heating element to apply heat to the cylinder. Variations of the method include the steps of programming the heating apparatus with polymer sleeve parameters and cylinder parameters such that the heating assembly generates the proper amount of heat and travels the appropriate distances to shrink wrap the cylinder assembly. Additional variations may include activating a conveyer belt system to the cylinder assembly into the heating apparatus and or activating a turntable on within the heating apparatus configured to rotate the cylinder assembly for even heat distribution.

The methods, systems, and apparatuses are set forth in part in the description which follows, and in part will be obvious from the description, or can be learned by the practice of the methods, apparatuses, and systems. The advantages of the methods, apparatuses, and systems will be realized and attained by means of elements and combinations particularly pointed out in the appended claims. It is to be understood that both the foregoing general description and the following detailed description are exemplary and explanatory only and are not restrictive of the methods, apparatuses, and systems, as claimed. More details concerning these embodiments, and others, are further described in the following figures and detailed description set forth herein below.

Those of ordinary skill in the art will understand and appreciate the foregoing description of the invention has been made with reference to certain exemplary embodiments of the invention, which describe an adjustable roof scaffold system and method of use. Those of skill in the art will understand that obvious variations in construction, material, dimensions or properties may be made without departing from the scope of the invention which is intended to be limited only by the claims appended hereto.

1.-14. (canceled)

15. A fluid cylinder shrink wrap system comprising:
a. a heating apparatus having a ventilated enclosure comprising a support base, and at least one heating assembly;
b. fluid cylinder assembly having a fluid cylinder disposed within a shrinkable polymer sleeve, the fluid cylinder assembly disposed within the heating apparatus and upon the support base; and
c. the at least one heating assembly coupled to a wall or the support base of the ventilated enclosure, the at least one heating assembly further having at least one heating element configured disperse heat within the ventilated enclosure onto the shrinkable polymer sleeve.

16. The fluid cylinder shrink wrap system of claim 15 wherein the heating apparatus further comprises a fan configured to circulate air across the at least one heating assembly providing convective heat transfer to the shrinkable polymer sleeve.

17. The fluid cylinder shrink wrap system of claim 16 wherein the heating apparatus further comprises locking members configured to lock the cylinder assembly in place through a compression fit on the cylinder assembly during the convective heat transfer in an area of the cylinder assembly not covered by the shrinkable polymer sleeve.

18. The fluid cylinder shrink wrap system of claim 15 further comprising support members coupled to side walls of the ventilated enclosure, the support members configured to support the cylinder assembly while insulating heat emanating from the at least one heating assembly beneath a releasable valve portion of the cylinder assembly.

19. The fluid cylinder shrink wrap system of claim 15 wherein the support base further comprises a turn table configured to continuously rotate the cylinder assembly during a heat transfer process to ensure even heat transfer from the heating assembly onto the shrinkable polymer sleeve.

20.-23. (canceled)

24. A method for protecting fluid-filled cylinders using a fluid cylinder shrink wrap system comprising the steps of:
disposing a shrinkable polymer sleeve onto a fluid-filled cylinder;
placing a cover over a valve of the fluid-filled cylinder;
placing the fluid-filled cylinder onto a support base of a heating apparatus;
applying support members from the heating apparatus to the fluid-filled cylinder at points above the shrinkable polymer sleeve and beneath the valve, insolating the valve from a heating element coupled to the heating apparatus; and
activating a heating element to apply heat to the fluid-filled cylinder and shrink the shrinkable polymer sleeve onto the fluid-filled cylinder.

25. The method for protecting fluid-filled cylinders using a fluid cylinder shrink wrap system of claim 24 further comprising the steps of programming the heating apparatus with polymer sleeve parameters and cylinder parameters such that the heating element generates a predefined amount of heat and translates corresponding distances to shrink wrap the fluid-filled cylinder.

26. The method for protecting fluid-filled cylinders using a fluid cylinder shrink wrap system of claim 24 further comprising the steps of calibrating motions sensors, switches, time of flight sensors, or laser/infra-red guides, to automatically detect a height of the fluid-filled cylinder, location of the valve, and location of the shrinkable polymer sleeve and perform a heat transfer process.

27. The method for protecting fluid-filled cylinders using a fluid cylinder shrink wrap system of claim 24 wherein the step of placing the fluid-filled cylinder onto the support base further comprises the steps of placing the fluid-filled cylinder onto a rotatable turntable and the steps of activating the heating element further comprises activating the turntable to rotate the fluid-filled cylinder for even heat distribution.

28. An indicia-bearing sleeve configured to protect a fluid cylinder, comprising
a substantially tubular member comprising a heat-shrinkable polymer material, the substantially tubular member having a wall with a first surface and a second surface opposing the second surface; and
the second surface being configured for reverse printing such that a non-reversed printed image is viewable through the first surface.

29. The indicia-bearing sleeve of claim 28, wherein the indicia-bearing sleeve further comprises a material selected from polyvinylchloride (PVC), polyethylene terephthalate (PET), polylactic acid (PLA), polytetrafluoroethylene, fluorinated ethylene propylene, perfluoralkoxy, ethylene tetrafluoroethylene, oriented polystyrene (OPS).

30. The indicia-bearing sleeve of claim 28 comprising PVC and a shrink ratio of about 50%.

31. The indicia-bearing sleeve of claim 28 comprising PET and a shrink ratio of about 65% to about 75% or about 50%.

32. The indicia-bearing sleeve of claim 30 wherein a diametric and length shrink percentage is about 7% to about 13% or about 4% to about 6%.

33. The indicia-bearing sleeve of claim 28 having a sleeve thickness ranging from about 0.07 mm to about 0.08 mm or 0.04 mm to about 0.065 mm.

34. The indicia-bearing sleeve of claim 28 wherein the second surface is further configured to be labeled by a rotogravure or through flexography.
